(19) United States
(12) Patent Application Publication
(10) Pub. No.: US 2004/0193515 A1
(43) Pub. Date: Sep. 30, 2004

(54) Account planning using an account planning tool

(76) Inventors: James K. Peterson, Denton, TX (US); Pamela H. Quin, Plano, TX (US)

Correspondence Address: BAKER BOTTS L.L.P., 2001 ROSS AVENUE, 6TH FLOOR, DALLAS, TX, 75201, US

(21) Appl. No.: 10/405,041

(22) Filed: Mar. 31, 2003

(51) Int. Cl. G06F 17/60

(52) U.S. Cl. 705/30

(57) ABSTRACT

In one embodiment, an account planning tool comprises computer software for organizing information concerning an account of an organization into a plurality of account planning categories, the account being associated with a client of the organization. The account planning tool comprises a relationship management category comprising relationship information. The relationship information comprises client surveys and a relationship development plan for developing personal relationships with the client. The account planning tool also comprises a growth category comprising growth information. The growth information comprises information regarding the background of the client and a new business development plan. The account planning tool also comprises a delivery category comprising delivery information. The delivery information comprises information regarding an information technology plan for aligning a client's technology with business needs of the client and delivery project plans for ensuring that certain contracted for services are delivered.

### TECHNICAL FIELD OF THE INVENTION

This invention relates generally to account planning and more particularly to account planning using an account planning tool.

### BACKGROUND OF THE INVENTION

Organizations often contract with a client to provide one or more goods or services to the client, the relationship with the client frequently being referred to as an account. An account may include one or more relationships or contracts with the client. Organizations may have a single account with a single client, single accounts with multiple clients, multiple accounts with the same client, or multiple accounts with multiple clients. Organizations may retain various types of information regarding the accounts of the organization. Organizations may desire to grow business with the account of the organization.

### SUMMARY OF THE INVENTION

According to the present invention, disadvantages and problems associated with previous techniques for account planning may be reduced or eliminated.

In one embodiment, an account planning tool comprises computer software for organizing information concerning an account of an organization into a plurality of account planning categories, the account being associated with a client of the organization. The account planning tool comprises a relationship management category comprising relationship information. The relationship information comprises client surveys and a relationship development plan for developing personal relationships with the client. The account planning tool also comprises a growth category comprising growth information. The growth information comprises information regarding the background of the client and a new business development plan. The account planning tool also comprises a delivery category comprising delivery information. The delivery information comprises information regarding an information technology plan for aligning a client's technology with business needs of the client and delivery project plans for ensuring that certain contracted for services are delivered.

Particular embodiments of the present invention may provide one or more technical advantages. For example, in certain embodiments, an account planning tool may provide a single repository for account planning information. The account planning tool may provide consistency of information within the organization as it relates to accounts of the organization. This consistency of information may improve the organization's relationships with clients of the organization. The account planning tool may improve the ability of the organization to train its employees in handling accounts of the organization and organizing information regarding the accounts of the organization. In certain embodiments, the account planning tool may allow leadership or other users with certain privileges to monitor the status of account planning information in the account planning tool.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates an example system for account planning using an account planning tool;

FIG. 2 illustrates an example method for providing security capabilities with an account planning tool; and

FIG. 3 illustrates an example method for determining the percentage of required fields for an account associated with the account planning tool that have been completed and generating a report.

### DESCRIPTION OF EXAMPLE EMBODIMENTS

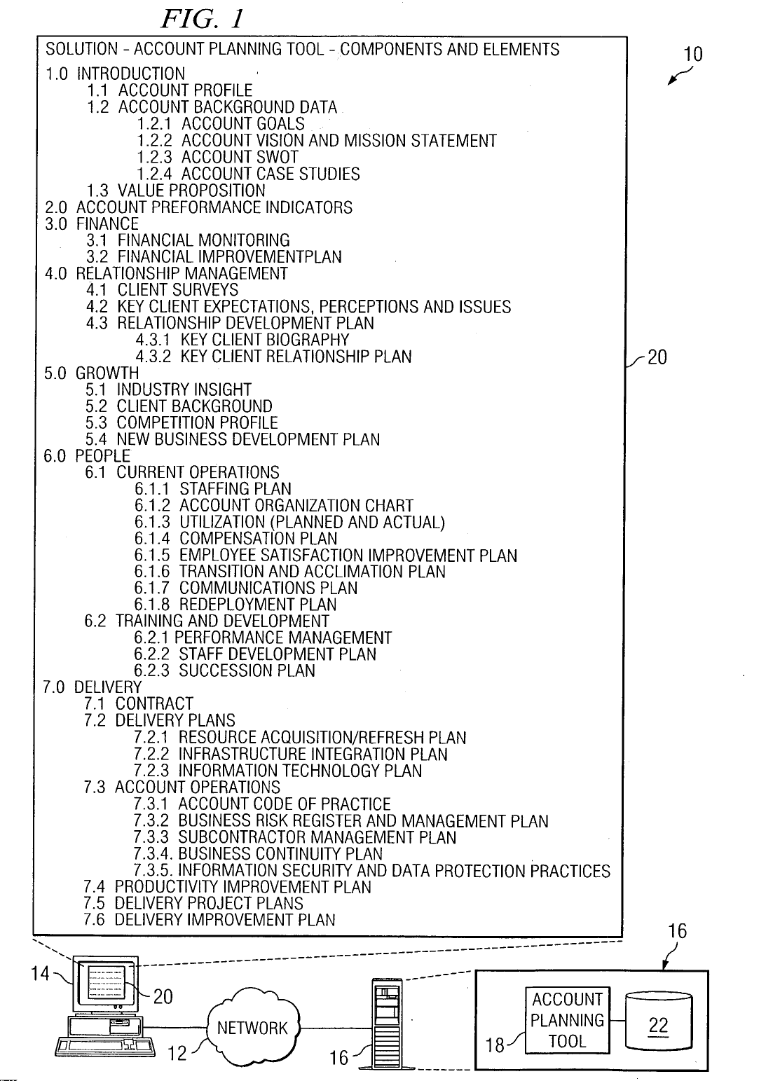

FIG. 1 illustrates an example system 10 for account planning using an account planning tool. In one embodiment, system 10 includes network 12, one or more users 14, and one or more server systems 16. Other embodiments of system 10 may be used without departing from the scope of this description. In general, system 10 may be used to organize information concerning an account of an organization into a plurality of account planning categories using the account planning tool.

In one embodiment, system 10 may be associated with an organization such as a company, corporation, partnership, or other suitable business entity. The organization may form business relationships by entering into one or more contracts or other agreements (oral or written) with one or more clients. A business relationship with a particular client may be referred to as an account of the organization. The organizations may have a single account with a single client, single accounts with multiple clients, multiple accounts with the same client, multiple accounts with multiple clients, or any other suitable number and combination of accounts and clients. In certain embodiments, the organization may have internal accounts.

The organization's accounts may vary in size and complexity. In certain embodiments, all accounts may have an associated account plan, which may vary according to the complexity of the business of the account. Some accounts may begin as projects but have the potential to grow into significant business for the organization. In one embodiment, an account that begins as a project should have an associated project plan that may include growth and relationship strategies. Certain accounts such as global accounts of the enterprise may require multiple account plans. The account plans for accounts requiring multiple account plans may be based around specific business functions, specific geography, or any other suitable characteristics of the account. In certain embodiments, the multiple account plans for a single account may be rolled up into a single, comprehensive account plan for the single account.

Collaboration may be desirable for the success of an account. For example, collaboration may be desired between sales organizations and sales teams within the organization, solution architects and delivery organizations within the organization, and account teams who will manage and grow business within the organization. Each of these different divisions of the organization may have specific roles and responsibilities that they will play in the management of an account. The account plan for an account may afford each of these divisions and individuals the opportunity to provide certain input into how the account will be defined and managed. The account plan may become a communication tool from which substantially all of the persons managing an account (account owners) may be able to operate. In one embodiment, specific roles and responsibilities in the development of an account plan may include a client executive associated with the account, a client delivery executive associated with the account, a sales team and sales support associated with the account, line-of-business representatives associated with the account, service delivery managers and client delivery managers associated with the account, one or more representatives from support units associated with the account, a client associated with the account, and any other suitable roles and responsibilities.

In one embodiment, the client executive associated with an account may have the ultimate responsibility for the creation and implementation of the account plan. The account and its ability to grow and deliver the contracted services to the client associated with the account may be the responsibility of the client executive. In certain embodiments, the client executive may delegate account-planning responsibilities to others, but in the final analysis, the client executive may be responsible to ensure the account plan is prepared and implemented.

In one embodiment, the client delivery executive associated with the account may have the responsibility of ensuring successful delivery to the client. In certain embodiments, the client delivery executive may be responsible for the growth of the account. The client delivery executive may be a liaison for some or all of the leveraged delivery organizations (if any exist) that may be responsible for delivering on the account. These leveraged delivery organizations may, for example, manage the day-to-day activities on the account and, in some embodiments, may have been delegated the responsibility of creating the account plan.

In one embodiment, the sales team and sales support associated with an account may include one or more persons who are responsible for selling new or existing business and for business development. The sales team, along the client executive in some cases, may set the growth and relationship direction and strategy for the sale of new business. In certain embodiments, the sales team and sales support personnel may be involved from the beginning of the account planning process. They may help define and set the sales and relationship strategies with the account and may be responsible for ensuring the delivery organizations are appropriately engaged and communicated with. In certain embodiments, as new growth strategies are defined on an account, the sales team and sales support may create or update the account plan.

In one embodiment, the line-of-business representatives may include representatives from the one or more lines-of-business servicing the account. In certain embodiments, line-of-business representatives will be included in the creation and implementation of the account plan, including representatives from the individual line-of-business sales and delivery organizations. Lines-of-business representatives may be included in growth opportunity identification sessions to determine what strategies and services may be needed from their respective lines of business.

In one embodiment, service delivery managers and client delivery managers associated with an account may be responsible to the client delivery executive and the client for the successful delivery of services as stated in the contract between the organization and the client. Service delivery managers may act as a liaison to any leveraged business organizations.

In one embodiment, the one or more representatives from support units associated with the account may be provided. Support units may include leadership groups, groups responsible for change, legal, finance, and any other suitable individuals or groups. In one embodiment, the client associated with the account may include the individual or entity with which the organization has contracted to provide services or products. In certain embodiments, the client may desire to participate in the account planning process. It may be desirable to hide certain categories of the account plan from the client, while it may be desirable to encourage client contribution to other portions of the account plan.

Users 14 may be referred to generally in the singular as user 14 or in the plural as users 14. User 14 may include appropriate input devices, output devices, mass storage media, processors, memory, or other suitable categories for receiving, processing, storing, and/or communicating information. In one embodiment, user 14 may include a computer, such as a personal computer, workstation, network computer, kiosk, wireless data port, datashow, wireless telephone, personal digital assistant (PDA), one or more processors within these devices, or any other suitable device. It should be understood that there may be any number of users 14 coupled to network 12. In one embodiment, users 14 may include leadership of the organization, the client executive, the client delivery executive, the sales team and sales support, the line-of-business representatives, the service delivery managers and client delivery managers, the one or more representatives from support units, the client, and any other suitable users, according to particular needs. Throughout this description, reference to any of these individuals, groups, or entities is also meant to be a reference to user 14.

Server system 16 includes one or more electronic computing devices operable to receive, transmit, process, and store data associated with system 10. For example, server system 16 may include a general purpose personal computer (PC), a Macintosh, a workstation, a UNIX-based computer, a server computer, wireless data port, datashow, wireless telephone, PDA, or any other suitable device. Server system 16 may be operable to communicate with user 14. For example, server system 16 may communicate with user 14 over network 12 (in real-time, batch, or a combination thereof). Or, in the alternative, it will be understood that user 14 and server system 16 may illustrate different modules included in the same computing device. The present invention contemplates user 14 and server system 16 being at the same or different physical locations. User 14 and server system 16 may be coupled to one another via network 12 that includes one or more computer buses, one or more local area networks (LANs), one or more metropolitan area networks (MANs), one or more wide area networks (WANs), at least a portion of a global computer network such as the Internet, or one or more other suitable wireline, optical, wireless, or other links. Server system 16 may also include a web server. One function of the web server (or a pool of servers) might be to allow user 14 to send or receive content over or from the Internet using a standard user interface language such as, for example, the Extended Markup Language (XML) or Hypertext Markup Language (HTML). Server system 16 may accept input from user 14 via a web browser (e.g., Microsoft Internet Explorer or Netscape Navigator) and return the appropriate HTML.

Server system 16 may include an account planning tool 18, which user 14 may use to organize information concerning an account of an organization into a plurality of account planning categories. Account planning tool 18 may be an interactive tool, and user 14 may interact with account planning tool 18 using a graphical user interface (GUI) 20. User 14 may input account information into GUI 20, and server 16 may store the account information in an associated memory 22. Any other type of interface could be used without departing from the scope of the invention.

Memory 22 may include any memory or database module and may take the form of volatile or non-volatile memory including, without limitation, magnetic media, optical media, random access memory (RAM), read-only memory (ROM), removable media, or any other suitable local or memory component. In one embodiment, memory 22 includes a SQL server.

The client executive associated with an account may ensure that the account plan is developed using, for example, an account planning team. Various stakeholders may participate in the development of the account plan. In addition, account planning tool 18 may facilitate the development of an account plan and act as a repository for some or all of the account planning information. In one embodiment, account planning tool 18 may be the primary development and repository tool used in the account planning process. Account planning tool 18 may be the single point of entry into various processes necessary to manage an account. In certain embodiments, linking account planning tool 18 to other suitable tools and applications and sharing data with these other tools and applications may help support account management. Account planning tool 18 may guide the account planning team through the account planning process. Account planning tool 18 may be a web-based application that includes help screens, examples, links, and templates for the account planning team to use throughout the account planning process.

The account planning process may begin at any suitable time. In certain embodiments, it may be desirable for the account planning process to begin when a potential client has been identified. Certain information gathered about the potential client may be populated or linked into the account planning tool as a potential deal with the potential client matures. As the potential deal matures, more information regarding the potential deal and the potential client may become available and may continue to be populated into account planning tool 18 to a point where the account plan may become more complete once a contract with the potential client has been signed. As the potential deal evolves, additional people with different roles and responsibilities may become assigned to the potential deal and may add their expertise and skills to the formulation of a solution for the client. This added information may be populated into account planning tool 18 and may lessen the overall risk of problems in serving the client.

Account planning tool 18 may include one or more account planning categories for organizing account planning information. In one embodiment, and without limitation, account planning categories may include an introduction category, an account performance indicator category, a finance category, a relationship management category, a growth category, a people category, a delivery category, and any other suitable account planning categories, singly or in any suitable combination. Although particular names are provided for the account planning categories, any suitable names may be used according to particular needs. The present invention contemplates any suitable number and types of account planning categories according to particular needs. A particular account planning category may contain one or more account planning sub-categories suitable for completing the particular account planning category. The account planning categories and account planning sub-categories may include one or more fields in which user 14 may input information, and in certain examples, the account planning sub-category may be considered fields of their associated account planning category.

Each account planning category and its associated account planning sub-categories and fields may be associated with one or more persons responsible for the information associated with the account planning category and its associated account planning sub-category and fields. The person responsible may be a user 14. This responsibility may include providing the information for the account planning category and its associated account planning sub-categories and fields, ensuring that the information for the account planning category and its associated account planning sub-categories and fields has been provided, or any other suitable responsibilities according to particular needs. Each account planning category and its associated account planning sub-categories and fields may be associated with a source, which may indicate where the source of the information for the account planning category and its associated account planning sub-categories and fields resides. The various account planning categories, account planning sub-categories, and the information within the account planning categories and sub-categories may be included as fields in a web-page or other suitable interactive document to be completed by members of the account planning team or other suitable individuals. The account planning categories, account planning sub-categories, and fields may be arranged logically in a hierarchy that may be displayed to user 14 using GUI 20, for example. Certain of the account planning categories and their associated account planning sub-categories and fields are described in detail below.

Introduction Category

In one embodiment, an introduction category may include an account profile sub-category, an account background data sub-category, and a value proposition sub-category.

The account profile sub-category may include high-level overview information regarding the account associated with the account plan. The account profile sub-category may include line of business information. The line of business information may include one or more lines of business with which the account is associated. The person responsible for the line of business information may include a client executive for the account associated with the account plan or any other suitable person or entity. The source of the line of business information may include a business unit that has a majority piece of the business for the account associated with the account plan.

The account profile sub-category may include initial contract start date information, which may include the date that the account associated with the account plan is expected to start providing services to a client associated with the account. In certain embodiments, the initial contract start date may not be the date of signing a contract with the client associated with the account. The person responsible for the initial contract start date information may include a client executive for the account associated with the account plan or any other suitable person or entity.

The account profile sub-category may include estimated total revenue information, which may include the total amount of revenue expected for a specific year. In one embodiment, the estimated total revenue information may include estimated revenue for estimated add-on business. The person responsible for the estimated total revenue information may include a client executive for the account associated with the account plan or any other suitable person or entity. The source of the estimated total revenue information may include a point of sale (POS) model associated with the account.

The account profile sub-category may include contract type information, which may specify the type of contract and which may, in certain embodiments, be specific to the type of services that are being provided to the client associated with the account. The person responsible for the contract type information may include a client executive for the account associated with the account plan or any other suitable person or entity. The source of the contract type information may include the contract with the client associated with the account.

The account profile sub-category may include other contract type information, which may specify the types of contracts that may be the result of add-on business associated with the account. The person responsible for the other contract type information may include a client executive for the account associated with the account plan or any other suitable person or entity. The source of the other contract type information may include the contract with the client associated with the account.

The account profile sub-category may include contract end date information, which may include the date the contract with the client associated with the account is scheduled to conclude. The person responsible for the contract end date information may include a client executive for the account associated with the account plan or any other suitable person or entity. The source of the contract end date information may include the contract with the client associated with the account.

The account profile sub-category may include account critical success factors, which may identify success factors that may be critical to the account. The person responsible for the account critical success factors may include a client executive for the account associated with the account plan or any other suitable person or entity. The source of the account critical success factors may include the contract with the client associated with the account or any other suitable source.

The account profile sub-category may include information regarding major accomplishments and deliverables. The person responsible for the information regarding major accomplishments and deliverables may include a client executive for the account associated with the account plan or any other suitable person or entity. The source of the information regarding major accomplishments and deliverables may include any suitable source.

The account profile sub-category may include general overview of the client information, which may provide a general overview of the client's one or more businesses. The general overview of the client information may include any level of detail, according to particular needs. As just one example, the general overview of the client information may include:

Client X administers programs that provide services to individuals and families in need. These programs are designed to both alleviate hardship and promote family health, personal responsibility, and economic independence. Client X serves a county of 9.8 million residents, larger in population than 42 states; an area of 4,083 square miles, encompassing 88 cities; and the needs of an ethnically and culturally diverse community.

The person responsible for the general overview of the client information may include a salesperson associated with the account, a sales development team associated with the account, a client executive associated with the account, or any other suitable person or entity. The source of the general overview of the client information may include information gathered during a sales process associated with the account and may be available in various documents prepared during the sales process.

The account profile sub-category may include client business issues information for client business issues that precipitated the contract with the client associated with the account. The client business issues information may include client business issues that were identified prior to or during initial contact with the client associated with the account. As just one example, the client business issues information may include:

Client Y's goal was to establish themselves as an independent manufacturer and key player in the electronic connector industry with aggressive goals for growth by internal improvements and strategic acquisitions. The company is growing through aggressive sales and acquisition strategy. The company hopes to be number two in the industry and have $2.0 billion in revenues by the year 2002. The company has a current critical need to have a totally integrated suite of systems to enable the operation of a global corporation.

The person responsible for the client business issues information may include a salesperson associated with the account, a sales development team associated with the account, a client executive associated with the account, or any other suitable person or entity. The source of the business issues information may include information gathered during a sales process associated with the account and may be available in various documents prepared during the sales process.

The account profile sub-category may include services provided information, which may include a listing of the current services that are being provided to the client associated with the account. The person responsible for the services provided information may include a client executive for the account associated with the account plan or any other suitable person or entity. The source of the services provided information may include the contract with the client associated with the account.

The account profile sub-category may include information regarding value-added services to the client, which may identify certain value-added services provided to the client by the organization. The person responsible for the information regarding value-added services to the client may include a client executive for the account associated with the account plan or any other suitable person or entity. The source of the information regarding the value-added services to the client may include any suitable source.

The account profile sub-category may include contract performance penalties information, which may include information regarding contract performance penalties associated with service level agreements (SLAs) defined for the account. The contract performance penalties information may focus on establishing performance thresholds and the consequences of not meeting them and may also be outlined as part of the terms and conditions of the contract with the client associated with the account. The person responsible for the contract performance penalties information may include a client executive for the account associated with the account plan or any other suitable person or entity. The source of the contract performance penalties information may include the contract with the client associated with the account.

The account profile sub-category may include partnership information, which may include information regarding any partners for providing services to the client associated with the account. The person responsible for the partnership information may include a salesperson associated with the account, a client executive associated with the account, or any other suitable person or entity. The source of the partnership information may include the contract with the client associated with the account and may be determined during a sales cycle associated with the account.

The account profile sub-category may include competitor information, which may include information regarding competitors who may be competing for business or who may already have business with the client associated with the account. The person responsible for the competitor information may include a salesperson associated with the account, a client executive associated with the account, or any other suitable person or entity. The source of the competitor information may include competitor profile documents associated with the account.

The account profile sub-category may include third-party intermediary and client-used consultants information, which may include one or more lists of third parties or consultants who are acting on behalf of the client associated with the account during a request-for-proposal (RFP) process. The person responsible for the third-party intermediary and client-used consultants information may include a salesperson associated with the account, a client executive associated with the account, or any other suitable person or entity. The source of the third-party intermediary and client-used consultants information may include various documents associated with the account, which may have been created during value selling RFP processes.

The account profile sub-category may include outside law firm information, which may include lists of outside law firms used by the client associated with the account. The outside law firm information may be useful when developing engagement strategies with the client. The person responsible for the outside law firm information may include a salesperson associated with the account, a client executive associated with the account, or any other suitable person or entity. The source of the outside law firm information may include value selling RFP processes.

The account profile sub-category may include location of contract folder for add-on business information. For example, as new business associated with a client is developed, the contract associated with the new business may be available in a defined location for reference purposes. The location of contract folder for add-on business information may include the defined location. The person responsible for the location of contract folder for add-on business information may include a client executive associated with the account or any other suitable person or entity. The source of the location of contract folder for add-on business information may include any suitable source according to particular needs.

The account profile sub-category may include account mailing address information, which may specify the mailing address for the account. The person responsible for the account mailing address information may include a client executive associated with the account or any other suitable person or entity. The source of the account mailing address information may include any suitable source according to particular needs.

The account profile sub-category may include account leadership information, which may specify various information regarding the leadership associated with the account. The person responsible for the account leadership information may include a client executive associated with the account or any other suitable person or entity. The source of the account leadership information may include any suitable source according to particular needs.

The account background data sub-category may include information designed to begin the planning process so that the account personnel may focus on the right objectives, goals, and strategies for delivering a desirable level of service to the client. The account background data sub-category may include account goals information, which may identify and/or describe one or more goals associated with the account. The person responsible for the account goals information may include a client executive associated with the account, a client delivery executive associated with the account, business partner leaders associated with the account, or any other suitable person or entity. The source of the account goals information may include any suitable source according to particular needs.

The account background data sub-category may include an account mission and vision statement, which may describe the future environment in which the client associated with the account will conduct business. The account mission and vision statement may help an account team associated with the account to determine what strategies the client associated with the account should adopt to achieve and maintain a competitive advantage in the future.

In one embodiment, in order to develop the account mission and vision statement, it may be critical that the account planning team understand the client's requirements and expectations. A review of the contract with the client and other relevant documents may provide much of this information. The account planning team may develop a view of the future environment in which the account may conduct business, and this analysis may help the account planning team to identify opportunities and threats facing the client. Inputs into the account mission and vision statement may include one or more of the following: competitor data; a client strategic business plan; a future business plan; a parent organization strategic business plan; planning boundaries; a planning horizon; stakeholder expectations; technology capabilities, usage, and issues; and any other suitable information.

The person responsible for the account mission and vision statement may include a client executive associated with the account, a client delivery executive associated with the account, business partner leaders associated with the account, or any other suitable person or entity. The source of the account mission and vision statement may include any suitable source according to particular needs and may be specific to the business associated with the account.

The account background data sub-category may include account key success factors information, which may include information regarding skill assets and abilities persons associated with providing services to the account may need to possess to provide a desired level of service to the client. In defining account key success factors information for an account, it may be important to have a clear understanding of the expectations of the client associated with the account and the contract deliverables. In certain embodiments, persons associated with the account may need to define critical success factors based upon these two factors and to prioritize the critical success factors from highest to lowest. There may be account key success factors for each account planning category (e.g., the account performance indicators category, the finance category, the relationship management category, the growth category, the people category, the delivery category, and any other suitable account planning category). In a preferred embodiment, it may be desirable to omit the account key success factors information or to include it in one or more other account planning categories or account planning sub-categories.

The person responsible for the account key success factors information may include a client executive associated with the account, a client delivery executive associated with the account, business partner leaders associated with the account, or any other suitable person or entity. The source of the account key success factors information may include any suitable source according to particular needs and may be based upon the competencies of the persons providing services to the client and the client's needs.

The account background data sub-category may include account strengths, weaknesses, opportunities, and threats (SWOT) information. Account SWOT information may help set the stage for what will need to be accomplished as well as setting priorities for what will be accomplished. Gathering account SWOT information may require planning participants to determine the SWOTs in the account relevant to delivering services to the client. Strengths may include a resource or ability on the account that can be used to take advantage of opportunities or to parry threats. Weaknesses may include a deficiency in the resources or abilities of an account, which may inhibit the account's ability to achieve its objectives and must be overcome to avoid failure. Opportunity may include an internal or external force or condition that can have a positive impact on the account. Opportunities may suggest a new basis for competitive advantage or present the possibility of improved performance of the account if pursued. Threat may include an internal or external force or condition that may have a negative impact on the account. Threats may impede the implementation of a strategy, increase the risk of a strategy, increase the resources required to implement strategy, or reduce the profitability and desirable level of service of the account.

The person responsible for the account SWOT information may include a client executive associated with the account, a client delivery executive associated with the account, business partner leaders associated with the account, or any other suitable person or entity. The source of the account SWOT information may include any suitable source according to particular needs and may be based upon the type of account and business that they are supporting.

The account background data sub-category may include account objectives information, which may include broadly defined statements of what the organization would like to accomplish during the planning period to achieve its vision. The account planning team associated with the account may use any suitable technique to formulate the account objectives information for the organization. In certain embodiments, the technique should be executed in a collaborative environment, ensuring that the relevant stakeholders are directly involved. In a preferred embodiment, it may be desirable to omit the account objectives information or to include it in one or more other account planning categories or account planning sub-categories.

Several tasks may be involved in developing account objectives information. A first task may include performing a gap analysis, during which the account planning team performs an analysis of the gap between where the organization is today and where it wishes to be. Using an implementing change methodology (ICM) may be very useful in establishing what change needs to occur. Within the ICM the areas of the organization, leadership, staff training and development, metrics, business and technology, performance measurement, relationship management, and communications may be assessed. A second task may include reviewing the account key success factors information, during which the account planning team may develop a list of actions that will help the account acquire the necessary skills and assets. This information may be a deliverable out of ICM transition strategies. A third task may include reviewing opportunities and threats defined in the account SWOT information, during which the account planning team develops a list of the opportunities and threats implied by the account mission and vision statement and summarizes this list into a top number of opportunities and a top number of threats. A fourth task may include deriving the account objectives information, during which the account planning team may analyze the items created in the first task and the second task. The items on the lists may correct current weaknesses, capitalize on current strengths, neutralize external threats, take advantage of opportunities, and move the account in the direction of the account mission and vision statement. A fifth task may include prioritizing the account objectives information, during which the account planning team may prioritize the list of objectives. In certain embodiments, it may be desirable to refer to the account key success factors information as one set of criteria against which account objectives can be prioritized.

The person responsible for the account objectives information may include a client executive associated with the account, a client delivery executive associated with the account, business partner leaders associated with the account, or any other suitable person or entity. The source of the account objectives information may include any suitable source according to particular needs and may be specific to the business associated with the account.

The account background data sub-category may include account barriers-to-success information, which may include those business activities, processes, and practices, which may prevent the account from reaching its account mission and vision, objectives, and goals. In one embodiment, the account planning team may determine what the barriers might include so that strategies may be put into place to overcome them. The person responsible for the account barriers-to-success information may include a client executive associated with the account, a client delivery executive associated with the account, business partner leaders associated with the account, or any other suitable person or entity. The source of the account barriers-to-success information may include any suitable source according to particular needs and may be specific to the account. In a preferred embodiment, it may be desirable to omit the account barriers to success information or to include it in one or more other account planning categories or account planning sub-categories.

The account background data sub-category may include account case studies information. Account case study information may include examples of account success in delivering solutions and resulting benefits to the client associated with the account. A case study may be an effective way to help win add-on business and to communicate success both internally and externally. The person responsible for the account case studies information may include a client executive associated with the account or any other suitable person or entity. The source of the account case studies information may include successes the account has had in delivering a desirable level of service to the client.

The value proposition sub-category may be formulated during a define phase of value selling process and may be designed to qualify the value that the organization may bring to the client associated with the account. The value proposition sub-category may include the following elements: (1) what will the client improve and by how much; (2) what capability must the client have in order to achieve the desired improvement; (3) what will the organization offer that will accomplish what needs to be done and what are the organization's strength; (4) what is the total cost; and (5) how and when will value be demonstrated? The person responsible for the value proposition sub-category may include a salesperson associated with the account, a business development team associated with the account, a client executive associated with the account, or any other suitable person or entity. The source of the account value proposition sub-category information may include any suitable source and may be developed and validated with the client during a sales cycle associated with the account.

Performance Indicators Category

In one embodiment, a performance indicators category may capture the performance metrics and measurements used to measure whether the organization is providing a desired level of service to the client as well as meeting one or more performance targets of the organization.

The performance indicators category may include service performance indicators information. Service performance indicators may include a standardized measure of the performance of a service offering, which has been contracted with the client. Service performance indicator information may include high-level measures of delivery performance at a service offering level that have been established as a market threshold within the organization. In certain embodiments, service performance indicator information may be modified to measure against client thresholds as established in the contract with the client. In certain embodiments, service performance indicator information may not be intended to replace operational measures (e.g., budget versus actual, etc.) or any existing service level agreements with clients. The person responsible for the service performance indicators information may include a client executive associated with the account, a client delivery executive associated with the account, a service delivery executive associated with the account, or any other suitable person or entity. The source of the account service performance indicators information may include any suitable source.

The performance indicators category may include client value metrics information, which may include specific measurements used to determine whether the value propositions in the value propositions sub-category are providing the contracted value to the client. In certain embodiments, the client value metrics information may be baselined at the signing of the contract with the client. The person responsible for the client value metrics information may include a client executive associated with the account, a client delivery executive associated with the account, or any other suitable person or entity. The source of the client value metrics information may include a value proposition made to the client or any other suitable source.

The performance indicators category may include operational metrics information, which may include metrics that are outlined within the contract with the client in the form of service level agreement, which may be used to measure performance of the organization under the contract. The person responsible for the operational metrics information may include a client executive associated with the account, a client delivery executive associated with the account, a service delivery executive associated with the account, or any other suitable person or entity. The source of the operational metrics information may include the contract with the client or any other suitable source.

The performance indicators category may include internal metrics information, which may be defined and used by the account to monitor internal performance of the account to monitor internal performance of the account when providing a desired level of service to the client or growing the business. The person responsible for the internal metrics information may include a client executive associated with the account, a client delivery executive associated with the account, business partners associated with the account, or any other suitable person or entity. The source of the internal metrics information may include the line of business or executive leadership team, the internal leadership team, the client, or any other suitable source.

Finance Category

In one embodiment, a finance category may include information regarding the financial status of the account and the plans for improving the financial performance of the account. In certain embodiments, the financial category may include definitions of a common process for planning, integrating, deploying, and operating an information technology (IT) solution, possibly allowing a better understanding for managing and predicting IT budget needs. In one embodiment, the finance category includes a financial monitoring sub-category and a financial improvement plan sub-category.

The financial monitoring sub-category may include a periodic assessment of the financial plan of the account to determine if the financial plans are being properly executed to determine whether commitments to the client are being achieved to the client and the organization. The person responsible for the financial monitoring sub-category may include a client executive associated with the account, a client delivery executive associated with the account, a service delivery executive associated with the account, or any other suitable person or entity. The source of the financial monitoring sub-category may include any suitable source.

The financial improvement plan sub-category may include the financial improvement strategic targets of the account and the measures used to track the progress. The person responsible for the financial improvement sub-category may include a client executive associated with the account or any other suitable person or entity. The source of the financial improvement plan sub-category may include any suitable source.

The financial improvement plan sub-category may include the issue description information, which may include descriptions of a financial gap or issue relating to the account, which may need to be resolved. The issue description information may be part of the financial improvement plan, which is necessary in reducing financial variances. The financial improvement plan sub-category may focus many different areas of the account and, therefore, individuals responsible for these areas may need to be involved in defining the issues and putting a plan in place to resolve the issues. The person responsible for the issue description information may include a client executive associated with the account, a client delivery executive associated with the account, or any other suitable person or entity. The source of the issue description information may include any suitable source and may be based upon any identified financial gaps to be closed. These gaps may be identified during financial and business assurance reviews.

The financial improvement plan sub-category may include issue leader information, which may specify an issue leader for the account. The issue leader may include a person who is designated by a client executive for the account to be responsible for resolving the issue. The person responsible for the issue leader information may include the client executive associated with the account or any other suitable person or entity. The source of the issue leader information may include any suitable source.

The financial improvement plan sub-category may include impact-on-contribution information, which may capture the impact of the account's contribution in U.S dollars or any other suitable currency. The person responsible for the impact-on-contribution information may include the client executive associated with the account or any other suitable person or entity. The source of the impact-on-contribution information may include any suitable source and may be agreed upon by the account leadership team.

The financial improvement plan sub-category may include impact-on-margin percentage information, which may include the percentage amount in a whole number between zero and ninety-nine percent, for example, of the issue's impact on the account contribution margin. The person responsible for the impact-on-margin percentage information may include the client executive associated with the account or any other suitable person or entity. The source of the impact-on-margin percentage information may include any suitable source and may be agreed upon by the account leadership team.

The financial improvement plan sub-category may include impact-on-other-areas information, which may describe the impact that a particular financial issue has on any other account planning category. The person responsible for the impact-on-other-areas information may include the client executive associated with the account or any other suitable person or entity. The source of the impact-on-any-other-areas information may include the account leadership team or any other suitable source.

The financial improvement plan sub-category may include target end date information, which may include the date that an issue is to be completed. The person responsible for the target end date information may include the client executive associated with the account or any other suitable person or entity. The source of the target end date information may include the account leadership team or any other suitable source.

The financial improvement plan sub-category may include status information, which may indicate the current status of an issue relating to the financial improvement plan sub-category. In certain embodiments, the status information may be selected using a drop-down box in graphical user interface 20 of account planning tool 18. The person responsible for the status information may include the client executive associated with the account or any other suitable person or entity. The source of the status information may include any suitable source.

The financial improvement plan sub-category may include information regarding actions relating to issues, which may indicate one or more actions to be taken or recommended to be taken regarding one or more identified issues relating to the account. The person responsible for the information regarding actions relating to issues may include the client executive associated with the account or any other suitable person or entity. The source of the information regarding actions relating to issues may include any suitable source.

Relationship Management Category

In one embodiment, a relationship management category may include plans and strategies to build and strengthen the organization's relationship with the client. The person responsible for the relationship management category may include a client executive associated with the account or any other suitable person or entity. In one embodiment, the relationship management category may include a client surveys sub-category; a key client expectations, perceptions, and issues sub-category; and a relationship development plan sub-category.

The client surveys sub-category may include any suitable surveys with the client, within the organization, or with any other suitable source. Emphasis on a desired level of service may focus the organization on client satisfaction, referenceability, renewability, and delivery excellence. This focus may begin with listening to a client and sharing a wealth of information gathered throughout the organization and learning to build the desired level of service through one or more surveys. The person responsible for the client surveys sub-category may include the client executive associated with the account or any other suitable person or entity. The source of the client survey information may include any suitable source.

The key client expectations, perceptions, and issues sub-category may be used to define one or more performance expectations, provide an assessment of the client's perception of the current performance, and identify the top issues that the client has with the organization.

The key client expectations, perceptions, and issues sub-category may include the key client expectations, which may define the expectations of the client that have been agreed by the account to be reasonable and within the terms of the contract with the client. These expectations may have surfaced during the contract negotiations, in the contract itself through benchmarking clauses, in casual conversation with the business development team, in client meetings, or through any other suitable means. Key client expectations may be continually set and may be addressed with appropriate action plans. The person responsible for the key client expectations sub-category may include the client executive associated with the account or any other suitable person or entity. The source of the status information may include pre-contract discussions, a sales knowledge transfer phase of a business assurance review, client surveys, review meetings with the client, and any other suitable source.

The key client expectations, perceptions, and issues sub-category may include the client's expectations of the organization, which may include the client's expectations that have been agreed upon by the account to be reasonable and within the terms of the contract with the client. The person responsible for the client's expectations of the organization may include a client executive associated with the account, a client delivery executive associated with the account, business partners associated with the account, or any other suitable person or entity. The source of the client's expectations of the organization may include pre-contract discussions, client surveys, review meetings, or any other suitable source. In a preferred embodiment, it may be desirable to omit the client's expectations of the organization or to include it in one or more other account planning categories or account planning sub-categories.

The key client expectations, perceptions, and issues sub-category may include the client's perception of account performance, which may include how the client perceives the account to be performing. In certain embodiments, negatively perceived performance may initiate an action plan to deal with the appropriate issues, and positively perceived performance may be noted and used in future contract negotiations or add-on business. The person responsible for the client's perception of account performance may include a client executive associated with the account, a client delivery executive associated with the account, business partners associated with the account, or any other suitable person or entity. The source of the client's perception of account performance may include client review meetings, service surveys, or any other suitable source.

The key client expectations, perceptions, and issues sub-category may include a predetermined number of top issues, which may describe the predetermined number of top issues that are not being addressed to the satisfaction of the client. For example, in one embodiment the predetermined number of top issues includes the top three issues. The person responsible for the predetermined number of top issues may include a client executive associated with the account, a client delivery executive associated with the account, business partners associated with the account, or any other suitable person or entity. The source of the predetermined number of top issues may include client review sessions or any other suitable source.

The relationship development plan sub-category may document the activities and responsibilities for developing business relationships with key named individuals within the client's organization. In certain embodiments, having an up-to-date relationship development plan sub-category may be critical to continuous growth on the account. Roles, responsibilities, and action items, which may be included in the relationship management plan sub-category, may be defined before implementation. The person responsible for the relationship development plan sub-category may include a client executive associated with the account or any other suitable person or entity. The source of the relationship development plan sub-category may include client growth strategy planning, strategic value selling, a business development team, or any other suitable source.

The relationship development plan sub-category may include key client biographical information, which may include a biography for each key client that may be considered to be critical to the relationship with the account team. In certain embodiments, information within a client biography may need to be subject to certain confidentiality guidelines within the organization. If the client data collected here is not available in the public domain, then the account team may need to obtain a client's permission or approval to gather the information for the key client biographical information. In certain embodiments, access to the key client biographical information may need to be controlled and access may need to be limited to the person responsible for the account. The person responsible for the key client biographical information may include a client executive associated with the account, a client delivery executive associated with the account, business partners associated with the account, the sales development team associated with the account, or any other suitable person or entity. The source of the key client biographical information may include the client organizational chart, client publications, industry publications, the client, or any other suitable source.

The key client biographical information may include the name of the client, a title of the client, a nickname of the client, a phone number of the client, one or more assistants' names and phone numbers of the client, educational information of the client (e.g., degree type/where from), the birth date of the client, the hometown of the client, previous employer/title information of the client, hobbies and charities of the client, favorite restaurants of the client, trade organizations associated with the client, or any other suitable information according to particular needs. Information in these fields may be used to help understand the client and to establish a positive relationship with the client.

The relationship development plan sub-category may include a key client relationship plan, which may define the activities and responsibilities for developing and improving business relationships with key individuals within the client organization. The person responsible for the key client relationship plan may include a client executive associated with the account, a client delivery executive associated with the account, business partners associated with the account, or any other suitable person or entity. The source of the key client relationship plan may include the account leadership team or any other suitable source, and, in certain embodiments, a collaborative session may need to be held to determine the necessary relationship strategies that may be used on the account.

The key client relationship plan may include action and initiative information, which may support the overall account relationship development plan. In certain embodiments, an action or initiative includes one or more tasks that may need to be completed in order to complete a portion or all of the account relationship development plan. The person responsible for the action and initiative information may include a client executive associated with the account or any other suitable person or entity. The source of the action and initiative information may include any suitable source and may be derived from the account relationship development plan. The key client relationship plan may include the name of the client that the action or initiative is supporting, the title the client has within the client organization, the role of the client within the client organization, the status of the action or initiative, a primary account team member responsible for the relationship, a secondary account team member responsible for the relationship, the support external to the account that may be required to enhance the relationship with this client, a target completion date on which the action or initiative is to be completed, or any other suitable information.

The internal relationship plan sub-category may define the activities and responsibilities for developing and improving business relationships with key individuals within the organization. In certain embodiments, while the focus of the relationship management category is typically the client, it may be important to develop an internal relationship plan for the organization or third-party vendors. The use of an internal relationship plan may assist the account team in sorting out the many complexities of managing an account. The person responsible for the internal relationship sub-category may include a client executive associated with the account, a client delivery executive associated with the account, business partners associated with the account, or any other suitable person or entity. The source of the internal relationship plan sub-category may include the account leadership team or any other suitable source. In a preferred embodiment, it may be desirable to omit the definitions of the activities and responsibilities for developing and improving business relationships with key individuals within the organization or to include it in one or more other account planning categories or account planning sub-categories.

Growth Category

In one embodiment, a growth category may include new business growth or organic growth of existing business. The information needed to identify growth opportunities between new business and existing business may be different. For example, fewer unknowns may exist with existing business relative to new business. The person responsible for the growth category may include a client executive associated with the account or any other suitable person or entity. In one embodiment, the client executive associated with the account may have primary responsibility for growing the business associated with the account and, therefore, may be responsible for ensuring that a growth strategy is defined and implemented on the account. The source of the growth category may include client growth strategy planning processes, application growth initiative processes, or any other suitable source. The growth category may include an industry insight sub-category, a client background sub-category, a competition profile sub-category, and a new business development plan sub-category.

The industry insight sub-category may include business intelligence on a client. The person responsible for the industry insight sub-category may include a client executive associated with the account, a sales and development business development team associated with the account, and any other suitable person or entity. The source of the industry insight sub-category may include industry information, competitive intelligence documents, HOOVER AND EDGAR reports, and any other suitable sources.

The industry insight sub-category may include: (1) summary information, providing a high-level summary of the client's industry; (2) competitive information, providing a high-level overview of the competitive environment in the industry; (3) company strategies information, which may include strategies used by companies that are successful in the client's industry, mergers and acquisitions and divestitures that have affected the client's industry, and the effects of e-business on the client's industry; (4) market size and growth information; (5) market segment information about the different market segments in the industry; (6) geographic segmentation information, including information pertaining to the specific geographies applicable to the industry; (7) globalization information describing how globalization is affecting the industry; (8) restructuring information describing the effects of corporate restructuring on the industry; (9) environmental regulations describing the effects that environmental regulations are having on the industry; (10) governmental regulations describing the effects that governmental regulations have on the industry; (11) research and development and innovation information; and (12) any other suitable information.

The client background sub-category may include background information about the client associated with the account. The client background sub-category may include client profile information. In certain embodiments, the client profile information may be included in the introduction category in addition to or in place of being included in the client background sub-category of the growth category. The client background sub-category may include client critical business issues, objectives, and activities information, which may include strategies the client is attempting to use to address the issues. The client critical business issues, objectives, and activities information requested in this sub-category may be dependant on the account leadership team's knowledge of the client, the client's business, and the client's industry. The person responsible for the client critical business issues, objectives, and activities may include a client executive associated with the account, a sales and business development team associated with the account, a client sales executive, or any other suitable person or entity. The source of the client critical business issues, objectives, and activities may include discussions with the client, research from the business development team, or any other suitable source.

The client background sub-category may include client technology direction information, which may include a high-level description of the client's technology direction. The person responsible for the client technology direction information may include a client executive associated with the account, a sales and business development team associated with the account, a client sales executive associated with the account, or any other suitable person or entity. The source of the client technology direction information may include discussions with the client with regard to technology direction and preferences or any other suitable source.

The client background sub-category may include client competitive advantage information, which may describe the client's competitive advantages. The client's actions that contribute to the client's competitive advantages may represent potential account opportunities. The person responsible for the client competitive advantage information may include a client executive associated with the account, a sales and business development team associated with the account, a client sales executive associated with the account, or any other suitable person or entity. The source of the client competitive advantage information may include business intelligence information that is gathered or stored, the client executive associated with the account, or any other suitable source.

The client background sub-category may include ownership information, which may describe the ownership of the client. The person responsible for the ownership information may include a client executive associated with the account, a sales and business development team associated with the account, a client sales executive associated with the account, or any other suitable person or entity. The source of the ownership information may include business intelligence information that is gathered or stored, the client executive associated with the account, or any other suitable source.

The client background sub-category may include industry information, which may describe the client's industry. The person responsible for the industry information may include a client executive associated with the account, a sales and business development team associated with the account, a client sales executive associated with the account, or any other suitable person or entity. The source of the industry information may include business intelligence information that is gathered or stored, the client executive associated with the account, or any other suitable source.

The client background sub-category may include annual sales information specifying the client's annual sales. The person responsible for the annual sales information may include a client executive associated with the account, a sales and business development team associated with the account, a client sales executive associated with the account, or any other suitable person or entity. The source of the annual sales information may include business intelligence information that is gathered or stored, the client executive associated with the account, or any other suitable source.

The client background sub-category may include annual assets information specifying the client's annual assets. The person responsible for the annual assets information may include a client executive associated with the account, a sales and business development team associated with the account, a client sales executive associated with the account, or any other suitable person or entity. The source of the annual assets information may include business intelligence information that is gathered or stored, the client executive associated with the account, or any other suitable source.

The client background sub-category may include information regarding the client's forecasted growth. The person responsible for the information regarding the client's forecasted growth may include a client executive associated with the account, a sales and business development team associated with the account, a client sales executive associated with the account, or any other suitable person or entity. The source of the information regarding the client's forecasted growth may include business intelligence information that is gathered or stored, the client executive associated with the account, or any other suitable source.

The client background sub-category may include reporting currency information regarding the reporting currency of the client. The person responsible for the reporting currency information may include a client executive associated with the account, a sales and business development team associated with the account, a client sales executive associated with the account, or any other suitable person or entity. The source of the reporting currency information may include business intelligence information that is gathered or stored, the client executive associated with the account, or any other suitable source.

The client background sub-category may include information regarding the number of employees associated with the client. The person responsible for the number of employees information may include a client executive associated with the account, a sales and business development team associated with the account, a client sales executive associated with the account, or any other suitable person or entity. The source of the number of employees information may include business intelligence information that is gathered or stored, the client executive associated with the account, or any other suitable source.

The client background sub-category may include information regarding the CEO of the client, which may include an identification and/or other information regarding the CEO of the client. The person responsible for the information regarding the CEO of the client may include a client executive associated with the account, a sales and business development team associated with the account, a client sales executive associated with the account, or any other suitable person or entity. The source of the information regarding the CEO of the client may include business intelligence information that is gathered or stored, the client executive associated with the account, or any other suitable source.

The client background sub-category may include information regarding the client's financial condition. The person responsible for the information regarding the client's financial condition may include a client executive associated with the account, a sales and business development team associated with the account, a client sales executive associated with the account, or any other suitable person or entity. The source of the information regarding the client's financial condition may include business intelligence information that is gathered or stored, the client executive associated with the account, or any other suitable source.

The client background sub-category may include client global services spending information, which may include an estimate of the total money the client spends on global services. Global services may include high value consulting, solutions consulting, IT outsourcing, business process outsourcing, product life cycle management, or any other suitable services. The client global services spending information may be in any suitable currency or may be limited to a particular currency according to particular needs. The person responsible for the client global services spending information may include a client executive associated with the account, a sales and business development team associated with the account, a client sales executive associated with the account, or any other suitable person or entity. The source of the client global services spending information may include market research groups or any other suitable source. In certain embodiments, the client global services spending information may be estimated using industry averages, practices, and trends and may vary from client to client based on client-specific characteristics (e.g., size, business behavior, market position, etc.). The client global services spending information may initially be estimated as a percentage of revenue using rate tables and guidelines for each industry.

The client background sub-category may include client global services spending with the organization information, which may include the total money the client's global services spend with the organization. The client global services spending with the organization information may be in any suitable currency or may be limited to a particular currency according to particular needs. The person responsible for the client global services spending with the organization information may include a client executive associated with the account or any other suitable person or entity. The source of the client global services spending with the organization information may include financial reports, the client executive associated with the account, or any other suitable source.

The client background sub-category may include client global services spending with the organization as a percentage, which may include as a percentage amount, the amount the client's global services spend with the organization. The person responsible for the client global services spending with the organization as a percentage information may include a client executive associated with the account or any other suitable person or entity. The source of the client global services spending with the organization as a percentage information may include financial reports, the client executive associated with the account, the business development team, or any other suitable source.

The client competition profile sub-category may be designed to understand the strengths and weaknesses of the competition in order to develop appropriate strategies to grow business with the client. The person responsible for the competition profile sub-category may include a client executive associated with the account, a client sales executive associated with the account, a business development team associated with the account, and a sales and business development team associated with the account.

The client competition profile sub-category may include competitor names, the source of which may include a client executive associated with the account, a business development team associated with the account, or any other suitable source. The client competitor profile sub-category may include competitor strengths information, which may include a list of the top competitor strengths in the areas of management, marketing, finance and accounting, operations, and information systems. In certain embodiments, an assessment of the competitor's strength should be completed for each competitor on an account or who might be involved in securing new business. The source of the competitor strength information may include business intelligence information, onsite knowledge of the competitor, or any other suitable source. The client competitor profile sub-category may include competitor weaknesses information, which may include an assessment of the competitor's weaknesses in the areas of management, marketing, finance and accounting, operations, and information systems. In one embodiment, an assessment of the competitor's weaknesses should be completed for each competitor on an account or who might be involved in securing new business. The source of the competitor weaknesses information may include business intelligence information, onsite knowledge of the performance and customer satisfaction of the competitor, or any other suitable source.

The client competition profile sub-category may include competitor opportunities information, which may identify and evaluate trends and events that affect the competitor's social, cultural, demographic, geographic, political, legal, governmental, and technological characteristics. In one embodiment, understanding the competitor's potential opportunities gives the organization an opportunity to develop counter-strategies in an effort to secure additional business. The source of the competitor's opportunities information may include knowledge on the account, the business development team through their use of business intelligence, discussions with the client, or any other suitable source.

The client competition profile sub-category may include competitor threats information, which may identify and evaluate trends and events beyond the control of the competitor (e.g., social, cultural, demographic, geographic, political, legal, governmental, technological, competitive, etc.). The source of the competitor threats information may include knowledge on the account, the business development team through their use of business intelligence, discussions with the client, or any other suitable source.

The client competition profile sub-category may include information regarding one or more competitors' current strategies and activities. The information regarding the one or more competitors' current strategies and activities may identify strategies and activities that each competitor employs with respect to the client. The source of the information regarding one or more competitors' current strategies and activities may include knowledge on the account, the business development team through their use of business intelligence, discussions with the client, or any other suitable source.

The client competition profile sub-category may include organization competitive-advantage information, which may clarify the competitive advantages of the account with respect to the client, as compared to the key competitor. In one embodiment, the organization competitive-advantage information may be based on the competitor opportunities and threats that are the competitive advantage that the organization may bring to the client. In one embodiment the process to determine the organization competitive-advantage information may be to understand the opportunities and threats, identify the gaps, and determine the competitive advantage that the organization can bring to the client. The source of the organization competitive-advantage information may include any suitable source and be based on identifying and analyzing the opportunities and threats of the competitors compared to the strengths of the organization.

The client competition profile sub-category may include information regarding the client's spending with an identified competitor of the organization. The client's spending may be expressed in any suitable currency or may be limited to a particular currency according to particular needs. In one embodiment understanding what the client is spending with the identified competitor may provide an opportunity for the account to develop the strategies to win business away from the identified competitor. The source of the information regarding the client's spending with an identified competitor of the organization may include client information, business intelligence information on the account, industry knowledge, benchmarking information, third-party information, or any other suitable source.

The new business development plan sub-category may provide information for developing new business. The person responsible for the new business plan sub-category may include a client executive associated with the account, a client sales executive associated with the account, a sales and business development team associated with the account, or any other suitable person or entity. The new business development plan sub-category may include an opportunity name, which may identify a potential opportunity for new business. The source of the opportunity name may include the client executive associated with the account or any other suitable source. The new business development plan sub-category may include summary and description information for the potential opportunity for new business, the source of which may include the client executive associated with the account or any other suitable source.

The new business development plan sub-category may include cross-line-of-business implications and cross-geographic implications, which may be relevant to the potential opportunity for new business. This field should address the following questions: (1) are there any opportunities to engage multiple lines of business in this deal; (2) who are they; (3) where are they located; (4) what role will they play in the deal; and (5) any other suitable questions. The source of the cross-line-of-business implications and cross-geographic implications information may include the client executive and sales team review of the service offerings from the lines of business.

The new business development plan sub-category may include target start-date and end-date information regarding the potential opportunity for new business. The source of the target start-date and end-date information may include the client executive associated with the account, the client sales executive associated with the account, or any other suitable source. The new business development plan sub-category may include total contract value information, which may include an estimate of the total contract value for the potential opportunity for new business. The total contract value information may be expressed in any suitable currency or may be limited to a particular currency according to particular needs. The source of the total contract value information include the client executive associated with the account, a client sales executive associated with the account, a business development team associated with the client, or any other suitable source.

The new business plan sub-category may include information regarding the opportunity owner of the individual or team within the organization that has primary responsibility for the potential opportunity for new business; the win probability (i.e. as a percentage) of winning the contract for the new business; and the expected award date on which the new business is expected to close. The source of this information may include a client executive associated with the account, a client sales executive associated with the client, or any other suitable source.

The new business plan sub-category may include client problems information, which may specify any business problems that the client is trying to solve with a potential opportunity for new business. The source of the client problems information may include a business development team associated with the account or any other suitable source. The new business plan sub-category may include information regarding core competencies or top capabilities of the organization that may help deliver to the potential opportunity if the new business is won. The source of this information may include a client executive associated with the account, a client sales executive associated with the account, or any other suitable source.

The new business plan sub-category may include value proposition information, which may specify a value proposition for a potential opportunity for new business. The source of the value proposition information may include one or more documents created during the pursuit of the potential opportunity for new business.

The new business plan sub-category may include any additional comments, according to particular needs. The person responsible for any additional comments may include a client executive associated with the account or any other suitable person or entity. The source of any additional comments may include any suitable source.

The new business plan sub-category may include status information regarding a potential opportunity for new business. In certain embodiments the decision as to the status of the new business may be based upon the judgement of the client executive associated with the account. In certain embodiments, the status information may be selected using a drop-down box in graphical user interface 20 of account planning tool 18.

People Category

In one embodiment, a people category includes information regarding people care, which may include plans and strategies that reflect how the people resources assigned to an account will be managed. The people category may include information regarding work force planning, compensation planning, succession planning, employee training and development, and any other suitable information. The people category may include a current operations sub-category and a training and development sub-category.

The current operations sub-category may include employee-related plans and information regarding the current operations at the account, such as compensation plans, staffing plans, and communication plans. The person responsible for the current operations sub-category may include a client executive associated with the account, a client delivery executive associated with the account, leveraged business leaders associated with the account, and any other suitable person or entity. The source of the current operations sub-category may include any suitable source.

The current operations sub-category may include staffing plan information, which may enable leaders to effectively forecast, plan, identify, and deploy a work force that supports business plans and strategies at all levels of the organization. The person responsible for the staffing plan information may include a client executive associated with the account, business partners associated with the account, or any other suitable person or entity. The source of the staffing plan information may include any suitable source. The current operations sub-category may include the name of the staffing plan owner who has direct responsibility for the development and deployment of the staffing plan. In certain embodiments, there may be multiple owners of the staffing plan. The person responsible for providing the name of the staffing plan owner may include a client executive associated with the account, a client delivery executive associated with the account, business partners associated with the account, or any other suitable person or entity. The source of the name of the staffing plan owner may include account leadership (the client executive and the business partners associated with the account) or any other suitable source.

The current operations sub-category may include an account organization chart, which may depict the account structure. In one embodiment, the account organization chart should be reviewed at regular intervals to ensure that it is optimized for the delivery of services to the client. The person responsible for the account organization chart may include a client executive associated with the account, business partners associated with the account, or any other suitable person or entity. The source of the account organization chart may include the client, annual reports, business intelligence (e.g., from the sales, business development, and client sales executive teams), or any other suitable source.

The current operations sub-category may include utilization information (planned and actual), which may include information regarding a utilization plan. The utilization information may include the name of the utilization plan owner who has direct responsibility for the development and deployment of the utilization plan for the account. The person responsible for the name of the utilization plan owner may include the client executive associated with the account, the client delivery executive associated with the account, business partners associated with the account, or any other suitable person or entity. The source of the name of the utilization plan owner may include account leadership (e.g., the client executive and business partners associated with the account) or any other suitable source.

The current operations sub-category may include information regarding a compensation plan, which may outline a compensation structure for the account as well as indicate whether the individuals who are supporting the account have compensation plans put into place. The person responsible for the compensation plan may include a client executive associated with the account, business partners associated with the account, or any other suitable person or entity. The source of the compensation plan may include the client executive associated with the account, a client delivery executive associated with the account, or any other suitable source. The information regarding the compensation plan may include the name of the compensation plan owner who has direct responsibility for the development and deployment of the compensation plan for the account. In one embodiment, there may be multiple owners of the compensation plan. The person responsible for the name of the compensation plan owner may include a client executive associated with the account, a client delivery executive associated with the account, business partners associated with the account, or any other suitable person or entity. The source of the name of the compensation plan owner may include account leadership (e.g., the client executive and business partners associated with the account) or any other suitable source.

The current operations sub-category may include information regarding an employee satisfaction improvement plan. In certain embodiments, employee surveys collect employee views on issues that directly impact day-to-day experiences in the workplace. The employee satisfaction improvement plan may address employee issues that are identified during employee surveys or through other suitable means. The person responsible for the employee satisfaction improvement plan may include a client executive associated with the account, business partners associated with the account, or any other suitable person or entity. The source of the employee satisfaction improvement plan may include employee surveys, account leadership, or any other suitable source.

The current operations sub-category may include information regarding a transition and acquisition plan, which may be designed to provide an easy transition of personnel when a contract is signed and people will need to be acclimated to the organizational environment. In one embodiment, if client employees are transitioning to the organization, expert transition assistance may be necessary; however, account leadership may retain the overall responsibility for achieving a smooth transition. The person responsible for the transition and acquisition plan may include a client executive associated with the account, a client delivery executive associated with the account, business partners associated with the account, or any other suitable person or entity. The source of the transition and acquisition plan may include any suitable source.

The current operations sub-category may include information regarding a communication plan, which may address procedures and schedules for communicating among the client, the leadership of the organization, support organizations, account employees, and other suitable persons. The person responsible for the communication plan may include a client executive associated with the account, business partners associated with the account, or any other suitable person or entity. The source of the communication plan may include the collective thinking of the account leadership team.

The current operations sub-category may include information regarding a redeployment plan, which in the event of downsizing or account close-down, may provide for a smooth transition and take care of key individuals during the change. The person responsible for the redeployment plan may include a client executive associated with the account, business partners associated with the account, or any other suitable person or entity. The source of information for the redeployment plan may include contractual commitments, loss of business, productivity improvements, or any other suitable source. The information regarding the redeployment plan may include the name of the redeployment plan owner who has direct responsibility for the development and deployment of the redeployment plan associated with the account. In one embodiment, there may be multiple owners of the redeployment plan. The person responsible for the name of the redeployment owner may include a client executive associated with the account, a client delivery executive associated with the account, business partners associated with the account, or any other suitable person or entity. The source of the name of the redeployment plan owner may include account leadership (a client executive and business partners associated with the account) or any other suitable source.

The training and development sub-category may include information regarding the training and development of employees for the account. The person responsible for the training and development sub-category may include the client executive associated with the account, a client delivery executive associated with the account, business partners associated with the account, or any other suitable person or entity. In certain embodiments, the training and development sub-category may include performance management information.

The training and development sub-category may include information regarding a staff development plan, which may include a staff development plan for persons on the account. In certain embodiments, the staff development plan may fulfill the development and training needs of the associated employee while supporting the needs of the account that is supporting the client. The person responsible for the staff development plan may include the client executive associated with the account, a client delivery executive associated with the account, business partners associated with the account, or any other suitable person or entity. The source of the information regarding the staff development plan may include the strengths and weaknesses of the individuals on the account, the skills and knowledge necessary to support the account, or any other suitable source. The information regarding the staff development plan may include the name of the staff development plan owner who has direct responsibility for the development and deployment of the staff development plan associated with the account. In one embodiment, there may be multiple owners of the staff development plan. The person responsible for the name of the staff development plan owner may include a client executive associated with the account, a client delivery executive associated with the account, business partners associated with the account, or any other suitable person or entity. The source of the name of the staff development plan owner may include account leadership (a client executive and business partners associated with the account) or any other suitable source.

The training and development sub-category may include information regarding a succession plan. A succession plan may enable the account leadership to focus on retention, accelerate development, and prepare for future leadership needs on the account. Succession planning may include a process that identifies the positions that are key to the organization's business results and may create a diverse pool of qualified candidates for those positions. The person responsible for the succession plan may include a client executive associated with the account, a client delivery executive associated with the account, business partners associated with the account, or any other suitable person or entity. The source of the information for the succession plan may include the account organization chart or any other suitable source. The information regarding the succession plan may include the name of the succession plan owner who has direct responsibility for the development and deployment of the succession plan associated with the account. In one embodiment, there may be multiple owners of the succession plan. The person responsible for the name of the succession plan owner may include a client executive associated with the account, a client delivery executive associated with the account, business partners associated with the account, or any other suitable person or entity. The source of the name of the succession plan owner may include account leadership (a client executive and business partners associated with the account) or any other suitable source.

Delivery Category

In one embodiment, a delivery category may include information to help plan, manage, and measure service value to the client associated with the account, which may include developing and implementing plans for service delivery based on client expectations and contractual obligations, ensuring service delivery is performed effectively and efficiently, and measuring and managing delivery performance. In one embodiment, the delivery category may include a contract sub-category, a delivery plans sub-category, an account operations sub-category, a productivity improvement plans sub-category, a delivery project plans sub-category, and a delivery improvement plan sub-category.

In one embodiment, the contract sub-category may include information regarding the contract between the organization and the client. For example, the contract sub-category may include the contract between the organization and the client. In certain embodiments, the contract sub-category may be included in an account archive associated with account planning tool 18 rather than included in account planning tool 18 itself. For example, account planning tool 18 may include a link to the account archive or the account archive may be included as an account planning category. The contract sub-category may include the name of the person responsible for the contract sub-category, the title of the person responsible for the contract sub-category, the folder location of the contract sub-category, and any other suitable information according to particular needs. The person responsible for the contract sub-category may include any suitable person or entity. The source of the contract sub-category may include the contract between the organization and the client or any suitable source.

The delivery plan sub-category may include information regarding account technology plans and infrastructure integration and refresh plans. The person responsible for the delivery plan sub-category may include a client delivery executive associated with the account, business partners associated with the account, a client executive associated with the account, or any other suitable person or entity. The source of the delivery plan sub-category may include technology plans, infrastructure plans, refresh plans, or any other suitable source and may include a collaborative planning effort with the business partners to define and deploy these plans.

The delivery plan sub-category may include information regarding non-people related resource acquisition and refresh plans. The source of the information regarding non-people related resource acquisition and refresh plans may include a client delivery executive associated with the account, business partners associated with the account, a client executive associated with the account, or any other suitable person or entity. The source of the non-people related resource acquisition and refresh plans may include any suitable source.

The delivery plan sub-category may include information regarding an infrastructure integration plan, which may include the transition plan from the current client state to the organization. For example, this may involve providing sales support and implementation management for the transition from the client's current operational state to an organizational managed state as may be defined in the contract with the client. The source of the information regarding the infrastructure integration plan may include a client delivery executive associated with the account, business partners associated with the account, a client executive associated with the account, or any other suitable person or entity. The source of the information regarding the infrastructure integration plan may include the contract with the client or any other suitable source.

The delivery plans sub-category may include information regarding an information technology plan, which may provide information about current technology solutions and plans for future development. In certain embodiments, the information technology plan may provide a comprehensive approach for aligning a client's technology with its strategic business objectives by establishing the business context and defining an enterprise IT strategy, enterprise architectures, technology policies, transition plans, a governance structure, and a refresh process. The person responsible for the information regarding the information technology plan may include a client delivery executive associated with the account, a client executive associated with the account, or any other suitable person or entity. The source of the information regarding the information technology plan may include the client, consulting services of the organization, or any other suitable source.

The account operations sub-category may include plans and information regarding current daily operational activities at the account, such as business continuity plans and information security plans. The account operations sub-category may include information regarding an account code of practice, which may define the organizational structure and quality management practices and procedures for the account. In certain embodiments, the account code of practice may include details of account rules and responsibilities and define client processes and the procedures by which responsibilities are discharged and the processes implemented. In one embodiment, the account code of practice may include procedures and controls important to account operation, which may not be explicitly covered elsewhere in the account plan. The person responsible for the account code of practice may include a client delivery executive associated with the account, a client executive associated with the account, business partners associated with the account, or any other suitable person or entity. The source of the account code of practice may include any suitable source. In certain embodiments, account code of practice templates, instructions, and examples, may be included in account planning tool 18.

The account operations sub-category may include information regarding a business risk register and management plan, which may address avoidance and mitigation plans for business risks identified during the sales cycle, contract review, or ongoing account operations. The person responsible for the business risk register and management plan may include a client executive associated with the account, a client delivery executive associated with the account, business partners associated with the account, or any other suitable person or entity. The source of the information regarding the business risk register and management plan may include any suitable source.

The account operations sub-category may include information regarding a subcontractor management plan. Subcontracts may be identified and conducted so that they fall within the terms of the organization's main contract with the client. For example, if the organization's main contract with the client includes penalty clauses for late delivery, nonperformance, or other failure on the organization's part, the appropriate proportion of the risk may be passed on to the subcontractor in the form of suitable penalties for noncompliance with the terms of the subcontract. In certain embodiments, if there are no subcontractors on the account to be managed, the subcontractor management plan may be omitted. In certain embodiments, the subcontractor management plan should address roles and responsibilities, performance measures, projects, deliverables, and expectations. The person responsible for the subcontractor management plan may include a client delivery executive associated with the account, business partners associated with the account, a client executive associated with the account, or any other suitable person or entity. The source of the subcontractor management plan may include an account leadership team associated with the account, subcontractors associated with the account, or any other suitable source.

The account operations sub-category may include information regarding a business continuity plan, which may provide a set of practices that mitigate risk, assure the availability of essential services for the organization and the client (relevant to the services contracted for), and provide for the safety of employees during a disaster. In certain embodiments, the business continuity plan may include a business risk analysis and crisis management and contingency management plans, which together may comprise a disaster recovery plan. In one embodiment, records of periodic reviews and testing of the business continuity plan, along with records of actual testing, should be referenced. The business continuity plan may ensure that the business will continue in the event of a disaster. For example, whether this is a contracted service for the client or not, it may be incumbent upon the account to ensure that business as usual continues. The person responsible for the business continuity plan may include a client delivery executive associated with the account, business partners associated with the account, a client executive associated with the account, or any other suitable person or entity. The source of the business continuity plan may include the client delivery executive associated with the account, business partners associated with the account, or any other suitable source and development of the business continuity plan may be a collaborative effort. In certain embodiments, account planning tool 18 may include links to templates, examples, and other materials, which may help develop the business continuity plan.

The account operations sub-category may include information security and data protection practices, which may establish guidelines that ensure information owned and controlled by the organization is adequately protected from the time it is created or acquired, until such time it is destroyed or no longer requires protection. In certain embodiments, strict adherence to any policies developed using the information security and data protection practices information may ensure that unauthorized individuals are denied access to organization-owned or organization-controlled information and, as a result, the organization's business interests are not compromised. In certain embodiments, adherence to these policies may be mandatory. The person responsible for the information security and data protection practices information may include a client delivery executive associated with the account, business partners associated with the account, a client executive associated with the account, or any other suitable person or entity. The source of the information security and data protection practices information may include one or more of the stakeholders responsible for the protection of client and account data or any other suitable source. The information security and data protection practices information may include the name of a security plan owner who has direct responsibility for the development and deployment of the account security and data protection practices. In one embodiment, there may be multiple owners of the security plan. The person responsible for the name of the security plan owner may include a client delivery executive associated with the account, a client executive associated with the account, business partners associated with the account, or any other suitable person or entity. The source of the name of the security plan owner may include account leadership (a client executive and business partners associated with the account) or any other suitable source.

In one embodiment, the delivery category includes the productivity improvement plan sub-category. However, in certain embodiments, the productivity improvement plan sub-category may be undesirable.

The delivery project plans sub-category may specify plans to ensure that the contracted services are delivered. The delivery project plans may be important in planning the account's resources and associated support. The person responsible for the delivery project plans sub-category may include a client delivery executive associated with the account, business partners associated with the account, a client executive associated with the account, or any other suitable person or entity. The source of the delivery project plans sub-category may include the contract, the new business assurance review phase of the account initialization process, or any other suitable source.

The delivery improvement plan sub-category may address the actions to be taken, including completion dates, to deliver increased value to the client. For example, outcomes of the business assurance reviews may include action items that are put into action plans. Action items associated with the delivery of the services may be included in the delivery improvement plan sub-category. The person responsible for the delivery improvement plan sub-category may include a client delivery executive associated with the account, business partners associated with the account, a client executive associated with the account, or any other suitable person or entity. The source of the delivery improvement plan sub-category may include determinations made by the account leadership team subsequent to business assurance reviews regarding what delivery improvements should be made to improve value to the client or any other suitable source. In certain embodiments, the delivery improvement plan sub-category should be continually monitored through project plans to insure that all improvements are addressed.

In certain embodiments, account planning tool 18 may include one or more security capabilities for allowing an account plan administrator or other user 14 associated with the account to grant or deny certain privileges to the account plan categories, account plan sub-categories, and fields within the account plan categories. The account plan administrator or other user 14 may be the account executive responsible for the account or any other suitable person according to particular needs. For example, the account plan administrator may grant or deny read-only privileges, which allow user 14 to view but not alter information in one or more of the account plan categories, one or more of the account plan sub-categories, or one or more of the fields. As another example, the account plan administrator may grant or deny add privileges, which allow user 14 to add information to one or more of the account plan categories, one or more of the account plan sub-categories, or one or more of the fields. As yet another example, the account plan administrator may grant or deny edit privileges, which allow user 14 alter information in one or more of the account plan categories, one or more of the account plan sub-categories, or one or more of the fields. In one embodiment, these privileges are cumulative such that a user 14 having add privileges automatically has read privileges and a user 14 having edit privileges automatically has read and edit privileges. The privileges granted to a particular user 14 may depend on the user's role in developing the overall account plan for a particular account. Account planning tool 18 may store the privileges granted to each user 14 in memory 22 such that when a particular user 14 attempts to perform an operation using account planning tool 18, account planning tool 18 may access memory 22 to determine if the particular user 14 has been granted the privileges necessary to perform the operation. The account plan administrator may also deny access privileges altogether to a user 14 with respect to particular categories, sub-categories, or fields. This can be done by actively denying privileges or by failing to explicitly grant read (or better) privileges.

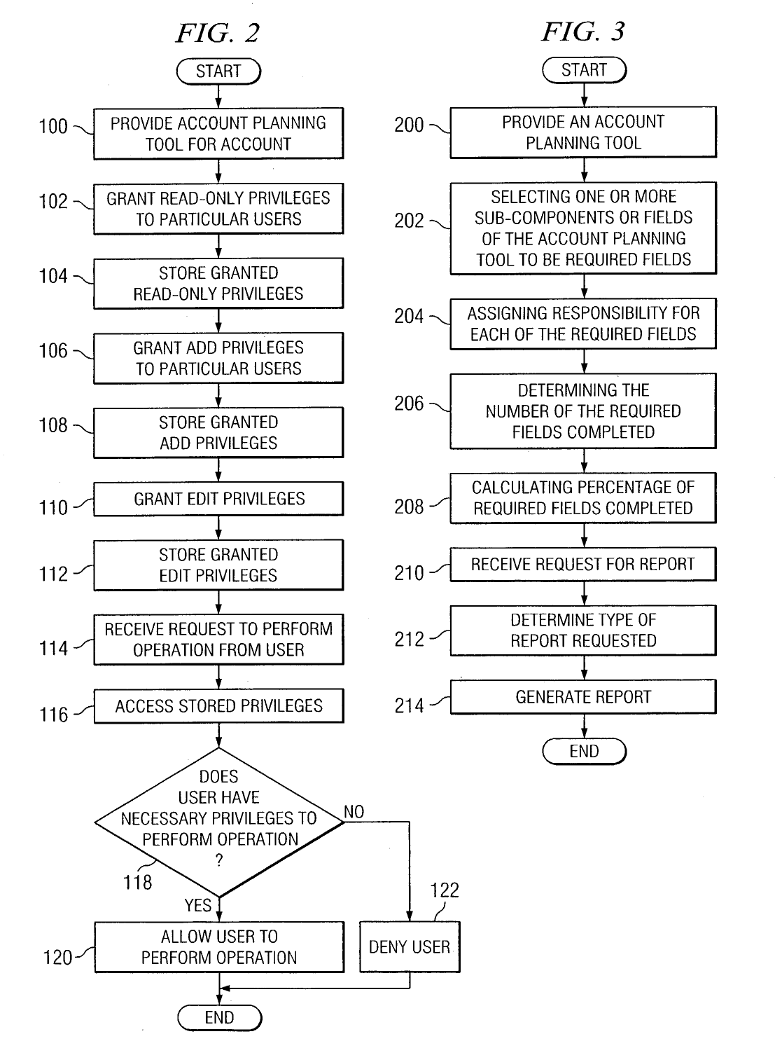

FIG. 2 illustrates an example method for providing security capabilities with account planning tool 18. At step 100, account planning tool 18 is provided. At step 102, the account plan administrator or other user 14 may grant read-only privileges to one or more users 14 using GUI 20 of account planning tool 18. Account planning tool 18 may store the granted read-only privileges and the users 14 associated with the granted read-only privileges at step 104. Account planning tool 18 may store the granted read-only privileges in memory 22, for example. At step 106, the account plan administrator or other user 14 may grant add privileges to one or more users 14 using GUI 20 of account planning tool 18. Account planning tool 18 may store the granted add privileges and the users 14 associated with the granted add privileges at step 108. Account planning tool 18 may store the granted add privileges in memory 22, for example. At step 110, the account plan administrator or other user 14 may grant edit privileges to one or more users 14 using GUI 20 of account planning tool 18. Account planning tool 18 may store the granted edit privileges and the users 14 associated with the granted edit privileges at step 112. Account planning tool 18 may store the granted edit privileges in memory 22, for example. As described above, these privileges may be cumulative such that a user 14 having add privileges automatically has read privileges and a user 14 having edit privileges automatically has read and edit privileges. The privileges granted to a particular user 14 may depend on the user's role in developing the overall account plan for a particular account.

At step 114, account planning tool 18 may receive a request from a particular user 14 to perform an operation using account planning tool 18. For example, the particular user 14 may attempt to access a particular field in the growth category of account planning tool 18. In response, account planning tool 18 may access the privileges stored on memory 22, for example, at step 116. At step 118, account planning tool 18 determines whether the particular user 14 has the necessary privileges to perform the requested operation. If the particular user 14 has the necessary privileges, the particular user 14 is allowed to perform the requested operation at step 120. If the particular user 14 does not have the necessary privileges to perform the requested operation, the particular user 14 is denied the right to perform the requested operation at step 122.

In certain embodiments, account planning tool 18 may determine a percentage of required fields for an account associated with account planning tool 18 that have been completed. For example, one or more of the account planning sub-categories and fields may be pre-selected as required fields. In one embodiment, the organization or one or more persons associated with the organization may base the selection of the required fields on which fields are the most critical in promoting a desired level of service to the client associated with the account. Account planning tool 18 may, automatically or in response to a request, determine the total number of required fields that have been completed. Account planning tool 18 may, automatically or in response to a request, use the total number of required fields completed and the total number of required fields to determine the percentage of the required fields that have been completed. Account planning tool 18 may determine the percentage of required fields completed for one account, multiple accounts for the same client, multiple accounts for different clients, all fields for one particular responsible person, or for any other suitable combination.

In certain embodiments, account planning tool 18 may generate one or more reports reflecting the percentage of the required fields that have been completed for one or more accounts. In one embodiment, account planning tool 18 generates the reports automatically on a monthly or quarterly basis, for example. In another embodiment, account planning tool 18 generates the reports in response to a request from user 14. In certain embodiments, user 14 must have certain privileges in order to request a report. A report may include: (1) an account and the percentage of the required fields completed for the account; (2) an account, a listing of the required fields for the account, and an indication of which of the required fields are complete; (3) more than one account of the organization and the percentage of the required fields complete for each account; (4) more than one account of the organization, a listing the required fields for each account, and an indication of which of the required fields are complete; (5) a listing of the person responsible for each of the required fields; or (6) any other suitable information in any suitable combination. In one embodiment, a report may be generated that includes all accounts for which a particular person has been assigned at least one required field, the particular person's required fields, and the percentage of the particular person's required fields that have been completed.

As an example, an executive board or other leadership entity overseeing an account may have delegated the gathering of account information regarding the account and the inputting of the account information in account planning tool 18 to one or more users 14. The executive may desire to periodically print a report illustrating which users 14 have completed the required fields for which they are responsible. The reports may allow those having primary responsibility for an account to monitor any work delegated to persons of responsibility for the required fields.

FIG. 3 illustrates an example method for determining the percentage of required fields for an account associated with account planning tool 18 that have been completed and generating a report. At step 200, account planning tool 18 is provided. One or more account planning sub-categories and one or more fields within account planning tool 18 are selected to be required fields at step 202. At step 204, an account executive or other person or entity associated with the organization may assign responsibility for the required fields of account planning tool 18. At step 206, the number of the required fields that have been completed is determined. Step 206 may be performed automatically by account planning tool 18 or in response to prompting from user 14. A required field may be considered complete according to any suitable definition and this definition may determine the quality or usefulness of the figure represented by the determined percentage of required fields that have been completed. At step 208, account planning tool may use the determined total number of required fields completed and the total number of required fields to determine the percentage of the required fields for account planning tool 18 that have been completed. Step 208 may be performed automatically by account planning tool 18 or in response to prompting from user 14.

At step 210, account planning tool 18 may receive a request for a report. In one embodiment, account planning tool 18 generates the report automatically on a monthly or quarterly basis, for example. In another embodiment, a user 14 having the appropriate rights may request a report using GUI 20 associated with account planning tool 18. At step 212, account planning tool 18 may determine the type of report requested. As described above, a report may include: (1) an account and the percentage of the required fields completed for the account; (2) an account, a listing of the required fields for the account, and an indication of which of the required fields are complete; (3) more than one account of the organization and the percentage of the required fields complete for each account; (4) more than one account of the organization, a listing the required fields for each account, and an indication of which of the required fields are complete; (5) a listing of the person responsible for each of the required fields; or (6) any other suitable information in any suitable combination. In one embodiment, a report may be generated that includes all accounts for which a particular person has been assigned at least one required field, the particular person's required fields, and the percentage of the particular person's required fields that have been completed. At step 214, account planning tool 18 generates the report. In certain embodiments, the report may be displayed on GUI 20, emailed to an email account of the user 14 that requested the report, or otherwise communicated to the user 14 that requested the report.

Particular embodiments of the present invention may provide one or more technical advantages. For example, in certain embodiments, account planning tool 18 may provide a single repository for account planning information. Account planning tool 18 may provide consistency of information within the organization as it relates to accounts of the organization. This consistency of information may improve the organization's relationships with clients of the organization. In certain embodiments, account planning tool 18 may prompt users 14 associated with the account to gather the appropriate information regarding the account, possibly further providing consistency of information regarding the account. Account planning tool 18 may improve the ability of the organization to train its employees in handling accounts of the organization and organizing information regarding the accounts of the organization. In certain embodiments, account planning tool 18 may promote collaboration within the organization in gathering information regarding accounts and in servicing the client associated with the account. In certain embodiments, account planning tool 18 may allow leadership or users 14 with certain privileges to monitor the status of account planning information in account planning tool 18.

Although the present invention has been described in detail, it should be understood that various changes, substitutions, and alterations can be made hereto without departing from the sphere and scope of the invention as defined in the appended claims.

To aid the Patent Office, and any readers of any patent issued on this application in interpreting the claims appended hereto, applicants wish to not that they do not intend any of the appended claims to invoke ¶ 6 of 35 U.S.C. §112 as it exists on the date of filing hereof unless “means for” or “step for” are used in the particular claim.

What is claimed is:

1. An account planning tool comprising computer software for organizing information concerning an account of an organization into a plurality of account planning categories, the account being associated with a client of the organization, the account planning tool comprising:
a relationship management category comprising relationship information, the relationship information comprising:
client surveys; and
a relationship development plan for developing personal relationships with the client;
a growth category comprising growth information, the growth information comprising information regarding:
the background of the client; and
a new business development plan; and
a delivery category comprising delivery information, the delivery information comprising information regarding:
an information technology plan for aligning a client's technology with business needs of the client; and
delivery project plans for ensuring that certain contracted for services are delivered.

2. The account planning tool of claim 1, further comprising a people category comprising information regarding:
a staffing plan for the account; and
a communication plan addressing procedures and schedules for communicating among parties associated with the account.

3. The account planning tool of claim 1, further comprising a finance category comprising financial information regarding the financial status of the account and plans for improving the financial performance of the account.

4. The account planning tool of claim 1, further comprising an account performance indicators category for capturing one or more performance metrics and measurements used to determine whether the organization is providing a desired level of service to the client associated with the account.

5. The account planning tool of claim 1, further comprising security capabilities granting or denying to at least one user of the account planning tool at least one of read-only privileges, add privileges, and edit privileges to information items associated with account planning categories, the granted privileges stored in a database associated with the account planning tool.

6. The account planning tool of claim 1, further comprising security capabilities granting or denying to at least one user of the account planning tool at least one of read-only privileges, add privileges, and edit privileges to one or more of the account planning categories, the granted privileges stored in a database associated with the account planning tool.

7. The account planning tool of claim 6, wherein, in response to receiving a request from a user for access to an account planning category, the account planning tool is operable to:
access the stored privileges to determine if the user has appropriate privileges to access the account planning category; and
if the user does not have the appropriate privileges to access the account planning category, deny the user access to the requested account planning category.

8. The account planning tool of claim 6, wherein, in response to receiving a request from a user for access to an account planning category, the account planning tool is operable to:
access the stored privileges to determine if the user has appropriate privileges to access the account planning category; and
if the user has the appropriate privileges to access the account planning category, grant the user access to the requested account planning category.

9. The account planning tool of claim 1, further comprising security capabilities granting or denying to at least one user of the account planning tool at least one of read-only privileges, add privileges, and edit privileges to one or more sub-categories, each sub-category associated with at least one of the account planning categories, the granted privileges stored in a database associated with the account planning tool.

10. The account planning tool of claim 1, further comprising security capabilities granting or denying to at least one user of the account planning tool at least one of read-only privileges, add privileges, and edit privileges to one or more of the account planning categories and one or more sub-categories associated with the one or more account planning categories, the granted privileges stored in a database associated with the account planning tool.

11. A system for planning accounts of an organization, comprising:
a computer readable storage medium;
an account planning tool stored on the computer readable storage medium and operable to organize account planning information concerning an account of the organization into a plurality of account planning categories, each account planning category comprising one or more information items to be populated by one or more users of the account planning tool, particular information items having been selected by the organization to be required information items of the account planning tool;
wherein the account planning tool is operable to:
calculate a completion percentage of the required information items for the account that have been populated with account planning information; and
generate a report comprising the completion percentage.

12. The system of claim 11, wherein the report generated by the account planning tool comprises:
the required information items of the account; and
the percentage of the required information items that have been populated.

13. The system of claim 12, wherein:
wherein one or more users are assigned responsibility for each required information item, the one or more users for a particular required information item being responsible for ensuring that appropriate account planning information is input into the particular required information item; and
wherein the report generated by the account planning tool further comprises an indication of the one or more users responsible for each required information item.

14. The system of claim 11:
wherein one or more users are assigned responsibility for each required information item, the one or more users for a particular required information item being responsible for ensuring that appropriate account planning information is input into the particular required information item; and
wherein the report generated by the account planning tool comprises:
a plurality of accounts for which a particular user is assigned at least one required information item;
the one or more required information items from each account assigned to the particular user of responsibility; and
the percentage of the required information items assigned to the particular user that have been populated with account planning information.

15. The system of claim 11, wherein the report generated by the account planning tool comprises:
a plurality of accounts of the organization;
the percentage of the required information items for each of the plurality of accounts that have been populated with account planning information.

16. A method for planning accounts of an organization, comprising:
providing an account planning tool for organizing account planning information concerning an account of the organization into a plurality of account planning categories, each account planning category comprising one or more information items to be populated by one or more users of the account planning tool;
selecting particular information items to be required information items of the account planning tool;
calculating a completion percentage of the required information items for the account that have been populated with account planning information; and
generating a report comprising the completion percentage.

17. The method of claim 16, wherein the report generated by the account planning tool comprises:
the required information items of the account; and
the percentage of the required information items that have been populated.

18. The method of claim 17, further comprising assigning one or more users responsibility for each required information item, the one or more users for a particular required information item being responsible for ensuring that appropriate account planning information is input into the particular required information item, the report generated by the account planning tool further comprising an indication of the one or more users responsible for each required information item.

19. The method of claim 16, further comprising assigning one or more users responsibility for each required information item, the one or more users for a particular required information item being responsible for ensuring that appropriate account planning information is input into the particular required information item, the generated report comprising:
a plurality of accounts for which a particular user is assigned at least one required information item;
the one or more required information items from each account assigned to the particular user; and
the percentage of the required information items assigned to the particular user that have been populated with account planning information.

20. The method of claim 16, wherein the report generated by the account planning tool comprises:
a plurality of accounts of the organization;
the percentage of the required information items for each of the plurality of accounts that have been populated with account planning information.
